(19) United States
(12) Patent Application Publication
(10) Pub. No.: US 2019/0047014 A1
(43) Pub. Date: Feb. 14, 2019

(54) SEAL PATTERN FORMING DEVICE

(71) Applicant: Sakai Display Products Corporation, Osaka (JP)

(72) Inventor: Tomochika NAKATANI, Sakai-shi (JP)

(73) Assignee: Sakai Display Products Corporation, Osaka (JP)

(21) Appl. No.: 16/076,533

(22) PCT Filed: Feb. 8, 2016
(86) PCT No.: PCT/JP2016/053706

§ 371 Date: Aug. 8, 2018

(51) Int. Cl. B05C 5/02; B05C 13/00; G02F 1/1339; G02F 1/13

(52) U.S. Cl. CPC B05C 5/0212; G02F 1/1303; G02F 1/1339; B05C 13/00

(57) ABSTRACT

A device forming a linear seal pattern (5) by applying a sealant to one surface of a substrate (3), wherein a gripping part (11) of a holding device (1) grips the peripheral edges of the substrate (3) and applies a tensile force along the surface to correct the warping and the deflection thereof while ensuring no local deformations formed thereon and then a sealant nozzle (2) that moves along the one surface of the substrate discharges a sealant to form the seal pattern (5). As a result, it becomes unnecessary to control the gap between the substrate (3) and the sealant nozzle (2), and a seal pattern (5) with uniform dimensions can be created quickly and reliably.

### TECHNICAL FIELD

The present invention relates to a device for forming a seal pattern on a surface of a substrate.

### BACKGROUND ART

A liquid crystal display panel includes an array substrate, a color filter substrate (a CF substrate), and a liquid crystal. The array substrate and the CF substrate are integrated such that one surface of the array substrate and one surface of the CF substrate are opposed to each other, and the liquid crystal is enclosed between the opposed surfaces. The one surface of the array substrate is provided with liquid crystal drive elements such as thin film transistors (TFTs) arranged in rows and columns. The one surface of the CF substrate is provided with color filters arranged in one-to-one correspondence with the liquid crystal drive elements. The two substrates are integrated such that a region where the liquid crystal drive elements are formed is located right opposite a region where the color filters are formed. A seal pattern is formed around the outside of these formation regions, providing a space for enclosing the liquid crystal.

Patent Literature 1 discloses a device for forming a seal pattern such as described above. This device forms a seal pattern by causing a dispenser filled with a sealant to travel along a surface of a substrate (an array substrate or a CF substrate) and applying a constant amount of the sealant discharged from a nozzle of the dispenser in a raised manner to form a line on the surface of the substrate.

The seal pattern is required to be formed to have constant dimensions (a line width and a raise height) in order to ensure enclosure of the liquid crystal and prevent interference with the liquid crystal drive element and color filter formation regions. In order to meet this requirement, the device disclosed in Patent Literature 1 performs sequential detection of a gap between a tip of the nozzle and the surface of the substrate as the dispenser moves, and controls the dispenser to move toward or away from the substrate based on a result of the detection. The above-described control allows the gap to be maintained constant against the relative position of the seal pattern formation surface varying due to deformity such as warpage and flexure of the substrate, and thus allows formation of a seal pattern having constant dimensions.

### CITATION LIST

### Patent Literature

### [Patent Literature 1]

### [Patent Literature 1]

Japanese Patent Application Laid-Open Publication No. 2007-232809

### SUMMARY OF INVENTION

### Technical Problem

Incidentally, the seal pattern formation is performed by conveying the substrate using a conveyance device having support arms in a fork-shaped arrangement and placing the substrate on a flat processing pedestal having a recess for receiving the support arms of the conveyance device. Recent liquid crystal display panel production tends to involve the use of a large thin substrate, which is often locally deformed in a portion on the aforementioned recess when placed on the processing pedestal.

In order that the device disclosed in Patent Literature 1 can handle a sharp variation in the gap in such a locally deformed portion, it is necessary to either increase responsiveness of the dispenser in movement toward and away from the substrate or decrease a traveling speed of the dispenser. However, the former makes the configuration of the device complicated, and the latter prolongs the seal pattern formation.

The present invention has been made in view of the circumstances described above, and an object thereof is to provide a seal pattern forming device having a simple configuration and being capable of quickly and stably forming a seal pattern having constant dimensions on a surface of a substrate.

### Solution to Problem

A seal pattern forming device according to an embodiment of the present disclosure includes a retainer and a sealant nozzle. The retainer grips at least two locations in a substrate and retains the substrate while stretching the substrate in a planar direction. The sealant nozzle discharges a sealant onto a processing surface of the substrate retained by the retainer while moving along the processing surface to form a seal pattern.

### Advantageous Effects of Invention

According to an embodiment of the present disclosure, it is possible to quickly and stably form a seal pattern having constant dimensions on a surface of a substrate.

### BRIEF DESCRIPTION OF DRAWINGS

FIG. 1 is a perspective view schematically illustrating a seal pattern forming device according to Embodiment 1.

FIG. 2A is an illustration of operation of the seal pattern forming device according to Embodiment 1.

FIG. 2B is an illustration of the operation of the seal pattern forming device according to Embodiment 1.

FIG. 2C is an illustration of the operation of the seal pattern forming device according to Embodiment 1.

FIG. 2D is an illustration of the operation of the seal pattern forming device according to Embodiment 1.

FIG. 3A is an illustration of operation of a seal pattern forming device according to Embodiment 2.

FIG. 3B is an illustration of the operation of the seal pattern forming device according to Embodiment 2.

FIG. 3C is an illustration of the operation of the seal pattern forming device according to Embodiment 2.

FIG. 3D is an illustration of the operation of the seal pattern forming device according to Embodiment 2.

FIG. 4A is an illustration of operation of a seal pattern forming device according to Embodiment 3.

FIG. 4B is an illustration of the operation of the seal pattern forming device according to Embodiment 3.

FIG. 4C is an illustration of the operation of the seal pattern forming device according to Embodiment 3.

FIG. 4D is an illustration of the operation of the seal pattern forming device according to Embodiment 3.

### DESCRIPTION OF EMBODIMENTS

The following describes embodiments of the present invention in detail based on the drawings.

### Embodiment 1

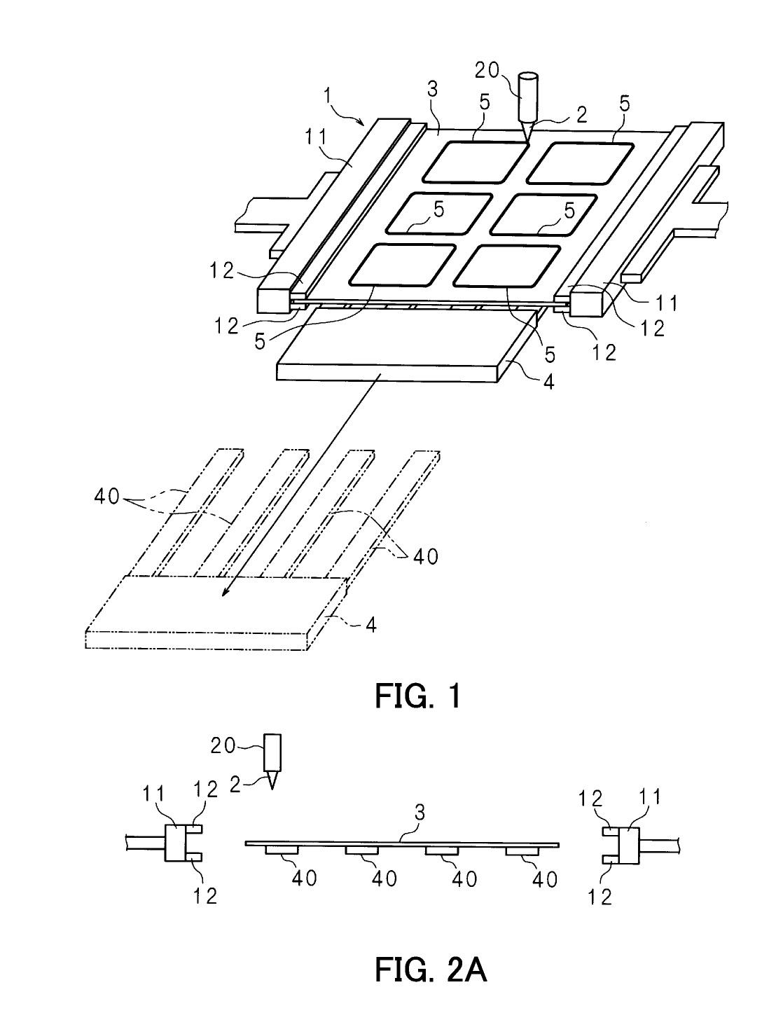

FIG. 1 is a perspective view schematically illustrating a seal pattern forming device according to Embodiment 1.

As illustrated in FIG. 1, the seal pattern forming device includes a retainer 1 and a sealant nozzle 2. The retainer 1 grips at least two locations in a substrate 3 and retains the substrate 3 while stretching the substrate 3 in a planar direction. The retainer 1 includes a plurality of (two, according to the present embodiment) gripping sections 11. The two gripping sections 11 according to the present embodiment are disposed in positions spaced on a substantially horizontal plane such that ends thereof for holding the substrate 3, which in other words are ends having gripping claws 12, are opposed to each other. The two gripping sections 11 are movable in directions toward and away from each other (in a direction toward each other and in a direction away from each other) and perform a gripping operation described below through the gripping claws 12, which open and close in an up-down direction. The movement of the gripping sections 11 toward and away from each other (movement in the directions toward and away from each other) and the gripping operation through the gripping claws 12 are implemented by combining a motion converting mechanism, a guide mechanism, and an actuator such as a motor, a pneumatic cylinder, and an electromagnetic cylinder as appropriate (not shown).

FIG. 1 shows the substrate 3 retained by the retainer 1 and a conveyance device 4 for the substrate 3. The substrate 3 is for example an array substrate that is used for production of a liquid crystal display panel. The substrate 3 is a thin rectangular glass plate having liquid crystal drive element formation regions on one surface thereof (a surface where a seal pattern is to be formed, which is referred to below as a “processing surface”). The conveyance device 4 includes a plurality of support arms 40 in a fork-shaped arrangement. The substrate 3 is placed and supported on the support arms 40 with the processing surface facing upward, and is conveyed in a substantially horizontal manner to a predetermined processing position between the two gripping sections 11 for seal pattern formation.

In FIG. 1, the substrate 3 conveyed to the processing position and the conveyance device 4 are represented by solid lines. The retainer 1 grips two opposite ends of the substrate 3 conveyed to the processing position using the two gripping sections 11, respectively, and retains the substrate 3 while stretching the substrate 3 in the planar direction with the processing surface facing upward. The conveyance device 4 stops supporting the substrate 3 and moves to a standby position as represented by dashed and double dotted lines in FIG. 1 after the retainer 1 starts retaining the substrate 3. Thereafter, an operation of the sealant nozzle 2 described below is performed to form a seal pattern on the processing surface of the substrate 3 retained by the retainer 1.

The sealant nozzle 2 is attached to a dispenser 20 and has a nozzle spout (not shown) facing the processing surface of the substrate 3 retained by the retainer 1. The sealant nozzle 2 is movable together with the dispenser 20 in longitudinal, lateral, and diagonal directions along the processing surface of the substrate 3 as well as in directions toward and away from the substrate 3. The movement in these directions is implemented by combining a motion converting mechanism, a guide mechanism, and an actuator such as a motor and a linear motor as appropriate (not shown).

The dispenser 20 sends out the sealant therein in a specific volume unit. The sealant nozzle 2 moves toward the processing surface of the substrate 3 retained by the retainer 1, and then discharges the sealant sent out from the dispenser 20 through the nozzle spout while moving along the processing surface of the substrate 3. Through the above, the sealant is applied in a raised manner to form a line on the processing surface of the substrate 3, and thus seal pattern parts 5 are formed on the processing surface of the substrate 3.

FIG. 1 shows an example of the thus formed seal pattern parts 5. Each of the seal pattern parts 5 in FIG. 1 has a rectangular frame-like shape surrounding a corresponding one of six liquid crystal drive element formation regions of the processing surface of the substrate 3. However, the shape and the number of the seal pattern parts 5 can be adjusted as appropriate by changing a travel path of the sealant nozzle 2. It should be noted that the dispenser 20 need not be movable. Another configuration may be employed in which the dispenser 20 is stationary, and the sealant nozzle 2 attached to the stationary dispenser 20 independently moves along the substrate 3 to form the seal pattern parts 5.

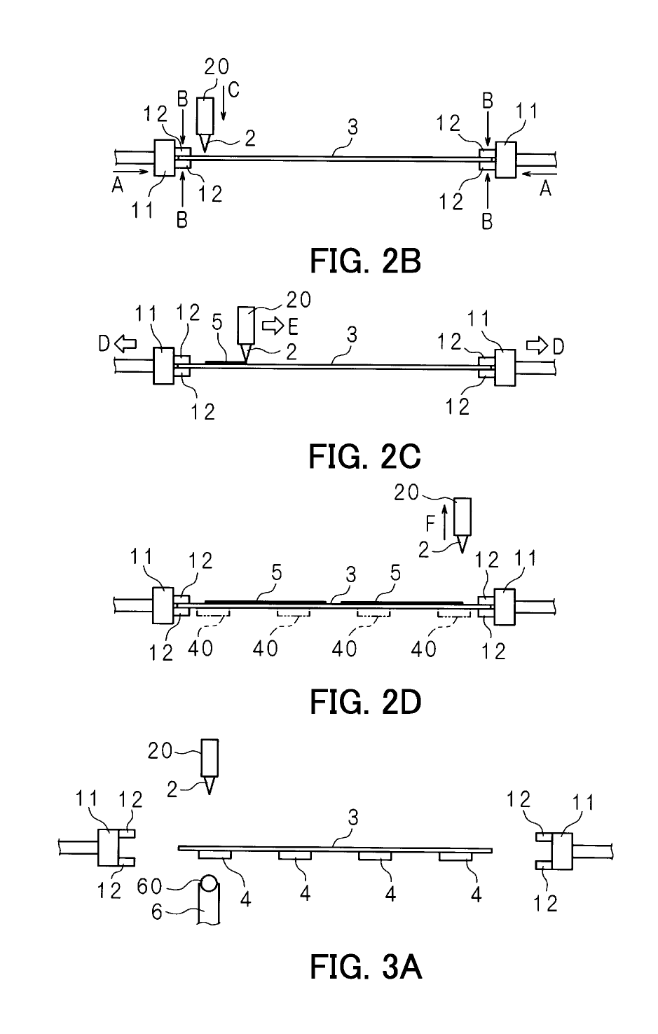

FIGS. 2A to 2D are illustrations of operation of the seal pattern forming device according to Embodiment 1. The operation described below is implemented through operation of a controller (not shown) in accordance with a preset control program.

FIG. 2A illustrates the substrate 3 supported on the support arms 40 of the conveyance device 4 and conveyed to the processing position. In FIG. 2A, the retainer 1 keeps the gripping sections 11 in a standby position where the gripping sections 11 are separated and respectively located on the opposite ends of the substrate 3 with the gripping claws 12 open, and the dispenser 20 and the sealant nozzle 2 are in a standby position upwardly away from the substrate 3. Thus, the conveyance device 4 can convey and position the substrate 3 into the processing position without interfering with the retainer 1 and the sealant nozzle 2.

Once the conveyance device 4 finishes conveying the substrate 3, the gripping sections 11 move toward each other as indicated by arrows A in FIG. 2B and respectively receive the opposite ends of the substrate 3 positioned in the processing position between the gripping claws 12. Next, the gripping sections 11 close the gripping claws 12 as indicated by arrows B in FIG. 2B so that the gripping claws 12 of each gripping section 11 hold the corresponding end of the substrate 3 across an entire length thereof, for example. The sealant nozzle 2 moves to an operational position in the vicinity of the processing surface of the substrate 3 by descending together with the dispenser 20 as indicated by an arrow C in FIG. 2B.

Next, the gripping sections 11 move away from each other as indicated by outlined arrows D in FIG. 2C. As a result of this movement, the retainer 1 retains the substrate 3 between the gripping sections 11 on the opposite ends with tensile force in the planar direction applied to the substrate 3. It should be noted that the conveyance device 4 stops supporting the substrate 3 and moves to the standby position after the gripping sections 11 start gripping the substrate 3 or after the gripping sections 11 start gripping and retaining the substrate 3 with the tensile force in the planar direction applied to the substrate 3.

After the retainer 1 starts retaining the substrate 3 with the tensile force in the planar direction applied to the substrate 3 (after the retainer 1 starts retaining the substrate 3), the sealant nozzle 2 discharges the sealant sent out from the dispenser 20 onto the processing surface of the substrate 3 while moving at a constant speed along the processing surface of the substrate 3 as indicated by an outlined arrow E in FIG. 2C. Through the above, the sealant is applied in a raised manner to form a line on the processing surface of the substrate 3, and thus the seal pattern parts 5 are formed on the processing surface of the substrate 3.

According to the present embodiment, the retainer 1 retains the substrate 3 with the tensile force in the planar direction applied to the substrate 3, and thus deformity such as warpage and flexure of the substrate 3 is corrected, so that the processing surface of the substrate 3 is suitably flat. The seal pattern forming device according to the present embodiment can therefore apply the sealant while maintaining a constant gap between the sealant nozzle 2 and the processing surface of the substrate 3 through the sealant nozzle 2 discharging the sealant while moving along a predetermined path. It is therefore possible to form the seal pattern parts 5 having constant dimensions, such as a line width and a raise height, without the need for complicated gap control.

Preferably, at least a portion of each of the gripping claws 12 of the gripping sections 11 that comes in contact with the substrate 3 is formed from an elastic material having a high friction coefficient such as rubber and resin. Thus, the substrate 3 can be prevented from being damaged when gripped, and the above-described tensile force can be stably applied without causing the substrate 3 to slip.

In the case of a large substrate 3 or a thin substrate 3, correction of flexure by application of the tensile force may be insufficient. In this case, it is only necessary to calculate the flexure of the substrate 3 based on the magnitude of the tensile force and perform simple control to change the position of the moving sealant nozzle 2 in the up-down direction according to a result of the calculation. Any deformation due to residual flexure of the substrate 3 spans the entire substrate 3 and is gentle, and can therefore be handled by gap control such as disclosed in Patent Literature 1 without posing the responsiveness problem.

After forming the seal pattern parts 5 on the entire surface of the substrate 3, the sealant nozzle 2 returns to the standby position by ascending together with the dispenser 20 as indicated by an arrow F in FIG. 2D. The support arms 40 of the conveyance device 4 come under and support the substrate 3 as represented by dashed and double dotted lines in FIG. 2D. Thereafter, the retainer 1 opens the gripping claws 12 of the gripping sections 11 and returns the gripping sections 11 to the standby position to give the substrate 3 to the conveyance device 4. The conveyance device 4 then conveys the substrate 3 for a next process.

### Embodiment 2

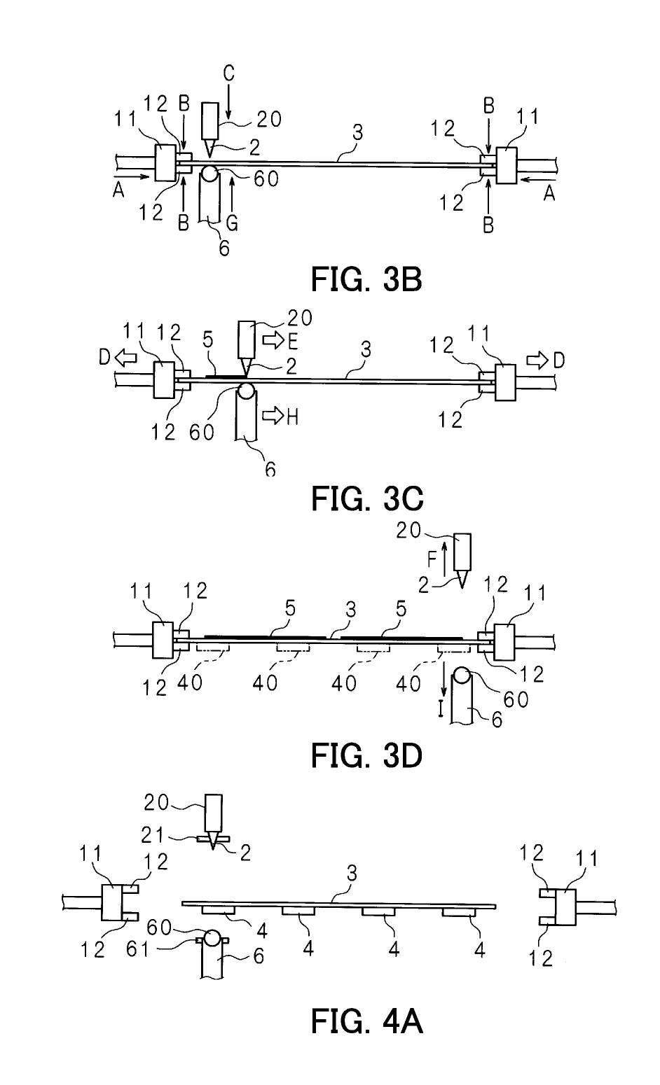

FIGS. 3A to 3D are illustrations of operation of a seal pattern forming device according to Embodiment 2. The seal pattern forming device shown in FIGS. 3A to 3D includes the retainer 1 and the sealant nozzle 2 having the same configuration as the seal pattern forming device according to Embodiment 1, and further includes a support 6 located opposite and under the sealant nozzle 2 with the substrate 3 in the processing position therebetween.

The support 6 is disposed in a position opposite the sealant nozzle 2 to support an opposite surface (a surface opposite to the processing surface) of the substrate 3 and is movable along the opposite surface of the substrate 3 in unison with the movement of the sealant nozzle 2. The support 6 according to the present embodiment has a rod-like shape extending in the up-down direction and holds, on an upper end thereof, a spherical rolling element 60 configured to roll in all directions. The support 6 is movable in longitudinal, lateral, and diagonal directions along the opposite surface of the substrate 3 as well as in directions toward and away from the substrate 3. The rolling element 60 rolls according to the movement of the support 6 along the opposite surface of the substrate 3. This movement of the support 6 is implemented according to the same configuration as the sealant nozzle 2. It should be noted that the support 6 is not limited to the rod-like shape and may have any appropriate shape.

FIG. 3A illustrates the substrate 3 conveyed to the processing position. In FIG. 3A, the retainer 1 and the sealant nozzle 2 are in the respective standby positions in the same manner as in Embodiment 1, and the support 6 is in a standby position under and away from the substrate 3. Thus, the conveyance device 4 can convey and position the substrate 3 into the processing position without interfering with the retainer 1, the sealant nozzle 2, and the support 6. The standby position of the support 6 corresponds to the standby position of the sealant nozzle 2 in a plan view.

The substrate 3 conveyed to the processing position is gripped by the gripping claws 12 of the gripping sections 11 as illustrated in FIG. 3B through the above-described operation of the retainer 1, and the sealant nozzle 2 moves to the above-described operational position by descending together with the dispenser 20. The operation of the retainer 1 and the movement of the sealant nozzle 2 are the same as in Embodiment 1 and are indicated by arrows A to C in FIG. 3B. The support 6 ascends from the standby position to an operational position as indicated by an arrow G in FIG. 3B to support the substrate 3 from below with the rolling element 60 on the upper end thereof in contact with the opposite surface of the substrate 3 under the sealant nozzle 2.

Next, the gripping sections 11 move away from each other as indicated by outlined arrows D in FIG. 3C, and the retainer 1 retains the substrate 3 between the gripping sections 11 on the opposite ends with the tensile force in the planar direction applied to the substrate 3. As in Embodiment 1, the conveyance device 4 stops supporting the substrate 3 and moves to the standby position after the gripping sections 11 start gripping the substrate 3 or after the gripping sections 11 start gripping and retaining the substrate 3 with the tensile force in the planar direction applied to the substrate 3.

After the retainer 1 starts retaining the substrate 3, the sealant nozzle 2 discharges the sealant sent out from the dispenser 20 onto the processing surface of the substrate 3 while moving at a constant speed along the processing surface of the substrate 3 as indicated by an outlined arrow E in FIG. 3C. Thus, the seal pattern parts 5 are formed on the processing surface of the substrate 3.

At the same time, the support 6 beneath the substrate 3 moves in unison with the movement of the sealant nozzle 2 as indicated by an outlined arrow H in FIG. 2C. That is, the support 6 moves in the same direction and at the same speed as the sealant nozzle 2 so as to stay in the position opposite the sealant nozzle 2 and keep supporting the opposite surface of the substrate 3. The support 6 moving in such a manner acts to maintain a constant gap between the substrate 3 and the sealant nozzle 2. It is therefore possible to form the seal pattern parts 5 having constant dimensions, such as a line width and a raise height, without the need for gap control even in a situation in which correction of flexure of the substrate 3 by application of the tensile force is insufficient.

The support 6 supports the substrate 3 through the rolling element 60 provided on the upper end thereof. The rolling element 60 is a sphere configured to roll in all directions and moves according to the movement of the support 6 while staying in contact with the opposite surface of the substrate 3. The moving support 6 can therefore keep supporting the substrate 3 without damaging the substrate 3.

After forming the seal pattern parts 5, the sealant nozzle 2 returns to the standby position by ascending as indicated by an arrow F in FIG. 3D. Likewise, the support 6 returns to the standby position by descending as indicated by an arrow I in FIG. 3D to stop supporting the substrate 3. The support arms 40 of the conveyance device 4 come under and support the substrate 3 as represented by dashed and double dotted lines in FIG. 3D. Thereafter, the retainer 1 stops retaining the substrate 3 to give the substrate 3 to the conveyance device 4. The conveyance device 4 then conveys the substrate 3 for a next process.

### Embodiment 3

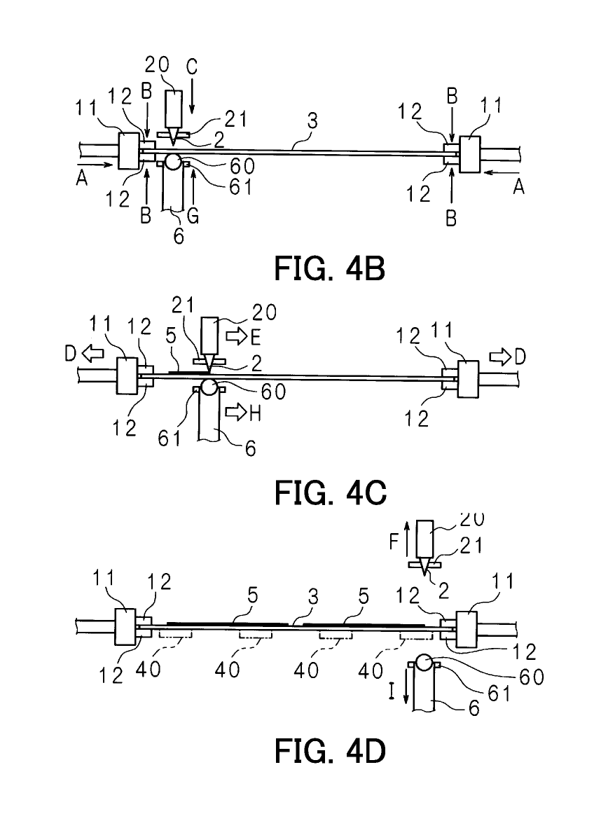

FIGS. 4A to 4D are illustrations of operation of a seal pattern forming device according to Embodiment 3. The seal pattern forming device illustrated in FIGS. 4A to 4D includes the retainer 1, the sealant nozzle 2, and the support 6 having the same configuration as the seal pattern forming device according to Embodiment 2. The sealant nozzle 2 and the support 6 respectively have a magnet 21 and a magnet 61 that exert repulsive forces to repel each other. Specifically, the magnet 21 is fixed to a tip portion of the sealant nozzle 2, and the magnet 61 is fixed to the upper end of the support 6. The magnets 21 and 61 according to the present embodiment are electromagnets that permit adjustment of the magnetic force, have poles opposite to each other, and exert the repulsive forces when opposed to each other.

An operation of forming the seal pattern parts 5 by the seal pattern forming device according to Embodiment 3 is performed in the same manner as with the seal pattern forming device according to Embodiment 2. As illustrated in FIG. 4B, the magnets 21 and 61 operate and exert specific repulsive forces while being closely opposed each other with the substrate 3 therebetween, and with the sealant nozzle 2 and the support 6 in the respective operational positions. The repulsive forces act to maintain a constant distance between the sealant nozzle 2 and the support 6 while the sealant nozzle 2 and the support 6 are moving as indicated in FIG. 4C. It is therefore possible to maintain a constant gap between the sealant nozzle 2 and the substrate 3 supported by the support 6 and form the seal pattern parts 5 having constant dimensions, such as a line width and a raise height, without the need for gap control.

After the seal pattern parts 5 are formed on the substrate 3, the sealant nozzle 2 and the support 6 return to the respective standby positions as illustrated in FIG. 4D. The retainer 1 then stops retaining the substrate 3 to give the substrate 3 to the conveyance device 4. The conveyance device 4 then conveys the substrate 3 for a next process.

The embodiments have been described above using examples in which the substrate 3 on which the seal pattern parts 5 are formed is an array substrate that is used for production of a liquid crystal display panel. However, the substrate 3 may be a CF substrate that is used for production of a liquid crystal display panel or any flat substrate that is used for a different purpose.

Furthermore, according to the above-described embodiments, the retainer 1 includes the two gripping sections 11 and applies the tensile force in the planar direction to the substrate 3 by gripping two locations in the substrate 3. However, the present invention is not limited to the embodiments. The retainer 1 may include three or more gripping sections 11 and apply tensile force in the planar direction to the substrate 3 by gripping three or more locations in the substrate 3. For example, the retainer 1 may include four gripping sections 11 to respectively grip the four ends of the substrate 3, and each pair of opposed gripping sections 11 among the four gripping sections 11 move away from each other to apply tensile force in the planar direction to the substrate 3.

Note that the presently disclosed embodiments are merely examples in all aspects and should not be construed to be limiting. The scope of the present invention is indicated by the claims, rather than by the description given above, and includes all variations that are equivalent in meaning and scope to the claims.

### REFERENCE SIGNS LIST

1 Retainer
2 Sealant nozzle
3 Substrate
5 Seal pattern part
6 Support
11 Gripping section
60 Rolling element
21, 61 Magnet

1. A seal pattern forming device comprising:
a retainer configured to grip at least two locations in a substrate and retain the substrate while stretching the substrate in a planar direction; and
a sealant nozzle configured to discharge a sealant onto a processing surface of the substrate retained by the retainer while moving along the processing surface to form a seal pattern.

2. The seal pattern forming device according to claim 1, further comprising
a support configured to support an opposite surface of the substrate to the processing surface and move along the opposite surface in unison with movement of the sealant nozzle while being disposed in a position on the opposite surface and opposite the sealant nozzle.

3. The seal pattern forming device according to claim 2, wherein
the support includes a rolling element disposed in contact with the opposite surface and configured to roll according to movement of the support.

4. The seal pattern forming device according to claim 2, wherein
the sealant nozzle has a magnet,
the support has a magnet, and
the magnets exert repulsive forces to repel each other.
